(19) United States
(12) Patent Application Publication
(10) Pub. No.: US 2016/0024342 A1
(43) Pub. Date: Jan. 28, 2016

(54) EXTREMELY FAST URETHANE-CELLULOSE COATING SYSTEM FOR APPLICATIONS IN POROUS AND THERMOPLASTIC MEDIA

(71) Applicant: COMPANHIA NITRO QUIMICA BRASILEIRA, Sao Paulo (BR)

(72) Inventors: Ludmila de Carvalho FIDALE, Sao Paulo (BR); Albio Calvete ROTTA, Sao Paulo (BR); Hugo WIZENBERG, Sao Paulo (BR); Oscimar Giacometti TORRES, Sao Paulo (BR); Reginaldo Faichel DA SILVA, Sao Paulo (BR)

(21) Appl. No.: 14/808,415

(22) Filed: Jul. 24, 2015

(30) Foreign Application Priority Data
Jul. 24, 2014 (BR) 10 2014 018191 1

(51) Int. Cl. C09D 175/08

(52) U.S. Cl. CPC C09D 175/08

(57) ABSTRACT

A nitrocellulose-based thermoplastic is provided and a urethane-cellulose system is generated that makes it possible to obtain varnishes and coatings with chemical resistance and thermal stability that maintain their polymer characteristics, without alteration of the substratum. The system generated is based on the reaction of nitrocellulose in solution and monofunctional isocyanates and shows the advantage of reducing the permeability of the dry film.

This nonprovisional application claims priority under 35 U.S.C. §119(a) to Brazilian Patent Application No. 10 2014 0181911, which was filed on Jul. 24, 2014, and which is herein incorporated by reference.

### FIELD OF THE INVENTION

Starting from a nitrocellulose-based thermoplastic, a urethane-cellulose system is generated that makes it possible to obtain varnishes and coatings with chemical resistance and thermal stability that maintain its polymer characteristics, without alteration of the substratum. The system generated starts with the reaction of nitrocellulose in solution and monofunctional isocyanates and offers the advantage of diminishing the permeability of the dry film.

### BACKGROUND OF THE INVENTION

The present invention has the objective of introducing a system known as “1K” for use on metal surfaces, based on wood or thermoplastics, using the nitrocellulose-isocyanate system in highly polar solvent medium.

The varnish/coating systems currently available make use of polyamide resins or acrylic urethane systems, whose disadvantages are the drying of the inks and varnishes involved in the systems mentioned.

For example, document US 2010/0272968 describes a urethane and nitrocellulose-based ink for graphical applications, where diamine resins of high molecular weight must be used as the starting material. Although representing a big step forward, this document is still restricted to a particular type of resin and amine.

Document U.S. Pat. No. 4,284,751, in turn, discloses a urethane-nitrocellulose-based sealant that adheres to glass surfaces and makes use of silicones.

Document U.S. Pat. No. 4,752,502 now discloses an ink for roadway demarcation that shows fast drying. Despite disclosing a fast-drying urethane-nitrocellulose-based ink, this document does not concern any other type of surface, it being restricted to roadway surfaces.

Document U.S. Pat. No. 5,556,925 discloses a printing ink for laminates in which there is the formation of a prepolymer, which is later reacted to form the system in urethane-nitrocellulose. This document does not disclose nor suggest the concept of forming varnish.

Document U.S. Pat. No. 6,506,823, in turn, turns to the formation of a nitrocellulose-based coating/varnish aiming at a system with low VOC generation. However, the teachings of this document disregard alternatives for fast drying.

Now the present invention works with the formation of a film on any type of surface and starts from the nitrocellulose formation reaction with isocyanate from hydroxyl groups.

### SUMMARY OF THE INVENTION

It is therefore an object of the present invention to apply a system known as 1K to metal, aluminum, wood-based, solid, agglomerate and reconstituted, or thermoplastic, polyethylene (PE), high or low density, torsional or metallized or bi-oriented (BOPP) polypropylene (PP), polyester, polyethylene terephthalate (PET), homopolymer or suspension-type vinyl polymer (PVC) surfaces; with or without electric (corona), thermal or chemical treatment, using a nitrocellulose-isocyanate system in highly polar solvent medium.

The varnish in accordance with the present invention is an alternative to the systems employed today, which use polyamide resins or acrylic urethane systems. The varnish in accordance with the present invention is also a system advantageously biodegradable and of high compatibility.

Polyamides show total compatibility in pure NC (nitrocellulose) and NC/PU (nitrocellulose-urethane) systems, in contrast to acrylic systems that show themselves incompatible with both pure NC and NC/PU systems, besides impairing the process speed.

Compatibilities are encountered in alkyd and polyester systems when in contact with pure NC or NC/PU.

The use of nitrocellulose-based urethane varnishes has its chemical beginning based on the reaction of the isocyanate group with free hydroxyls present in the nitrocellulose molecule, it becoming, in this case, a reactive polyol in organic polar solvent medium.

These varnishes possess the characteristic of having high molecular weight, show fast drying and, depending on the solvents used as solubilization medium, they could be free of or have low VOC.

The advantage of using nitrocellulose is its compatibility with isocyanate monomers, both aromatic and aliphatic, and their derivatives.

The advantage of urethane-nitrocellulose systems is the reduction of the permeability of the dry film, by means of neutralization of the residual hydrophilic groups.

The speed of drying and the ease of use lead to considering nitrocellulose-based urethane varnish an advantage in terms of application and time in the automobile repainting, wood and graphic arts fields.

The fact that nitrocellulose solution, urethanized or not, has a low content of polymer solids is considered an advantage in the graphic arts, since there is no formation of a thick layer on the substratum and, though being a low solid content system, it achieves high quality printing, because the pigments are highly compatible. Thus, mechanical application systems, which require that thin layers be transferred to the substratum, show good printing results.

The 1K nitrocellulose-urethanized system possesses a high degree of transference to the substratum and also ease of cleaning the equipment, considering that the products are highly soluble in solvents commonly used in the ink industry.

Additionally, nitrocellulose is a biodegradable product obtained from raw materials of renewable and nontoxic origin, such as cotton linter cellulose and wood cellulose from reforestation, or not.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the generic reaction of isocyanate with hydroxyl; and

FIG. 2 shows the proposed structure for the urethane-nitrocellulose system.

### DETAILED DESCRIPTION

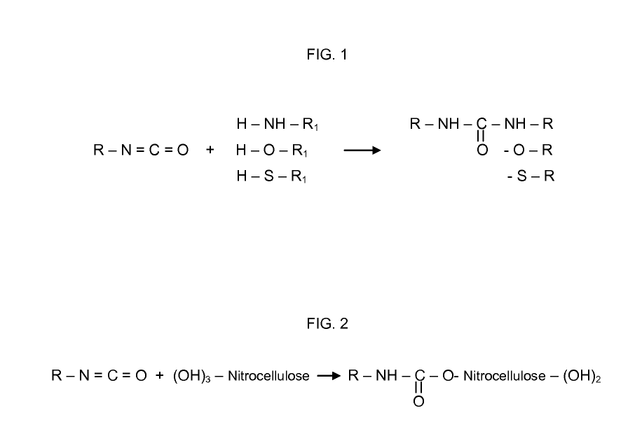

FIG. 1 shows the generic reaction of isocyanate with hydroxyl, and notes the unsaturated initial molecule and the addition with hydrogen donors, without the formation of byproducts.

Starting from an aromatic isocyanate of toluene diisocyanate (TDI), diphenylmethane diisocyanate (MDI), isophorone diisocyanate (IPDI) and hexane diisocyanate (HDI) type and nitrocellulose, the product in accordance with the present invention is obtained.

A solvent is used as reagent, such as glycols of the monoethylene glycol (MEG), diethylene glycol (DEG), propylene glycol, dipropylene glycol (DPG), triethylene glycol (TEG), MPdiol, 1,4-butanediol, 1,6-hexanedionol, tripropylene glycol (TPG) type, glycolic ethers of the type: monoethylene glycol methyl ether, monoethylene glycol ethyl ether, propylene glycol methyl ether, diethylene glycol methyl ether, triethylene glycol methyl ether, propylene glycol methyl ether, dipropylene glycol methyl ether, tripropylene glycol methyl glycolic ether and other ethers.

This reaction of the hydroxyl group with the isocyanate group occurs in solvent medium of organic acetate type totally free of humidity or any contamination with proton donor solvents. The product formed by this reaction has the advantage of forming film on surfaces of high electrostatic attraction, such as metal surfaces, besides the highest speed in terms of drying when compared with conventional varnishes.

Nitrocellulose is compatible with both aromatic and aliphatic isocyanates and their derivatives.

Aliphatic isocyanates are preferably used when the substratum or the varnish are directly affected by the outside environment, e.g., light, ultraviolet rays, solar light or any action of direct exposure to light beams.

Aromatic isocyanates are preferably used in inside systems or systems that will not have direct exposure to light, solar rays, ultraviolet light or any presence of light beams.

The present invention uses aromatic isocyanates such as toluene diisocyanate trimers, toluene diisocyanate adducts with polyols such as trimethylolpropane and diphenylmethane diisocyanate resins.

The nitrocellulose used in the present invention possesses a nitrogen content between 10.8% and 12.3%.

The most suitable nitrocellulose viscosity is in the range of ½ second, ¼ second, 5-6 seconds, 18-25 seconds and 10-15 seconds.

The viscosity methodology used is ASTM D301-95 (Standard Test Methods for Soluble Cellulose Nitrate).

High viscosity nitrocellulose of the ½ second and 5-6 seconds type produces inks/coatings/varnishes of low solid content and low thickness.

Low viscosity nitrocellulose, with lower viscosity than the viscosities mentioned above, produces higher solid content than the previous ones, of ½ second and 5-6 seconds, such as NC of 18/25 seconds and 10-15 seconds.

In the present invention, it works in both the high viscosity and the low viscosity range.

Normally, catalysts are used to promote the reaction between isocyanates and hydroxyls, the most used being based on bismuth, zinc, tin, potassium, cobalt and zirconium, of 2-ethyl hexanoate type, in the form of an ester.

The characteristic reaction of isocyanates with hydroxyls occurs by an addition mechanism, where the double bond existing between the carbon atom and the nitrogen atom, both characteristic of the isocyanate group, is broken, and a hydrogen atom, originating from the proton donor group, directly bonds to the nitrogen, forming a typical urethane bond.

These reactions occur with proton donor groups, such as primary amino, secondary amino, primary alcohol, secondary alcohol, tertiary alcohol, glycols, glycol esters, polyglycols, glycolic polyethers, besides other compounds that are proton donors.

In this specific case, of the reaction of an aromatic type isocyanate with the nitrocellulose molecule, there is the same mechanism described above, only differing due to the fact that the polyol used is a natural polymer composed only of hexoses, more specifically of glucose, chemically modified through direct partial esterification of the hydroxyl groups with nitro groups, leaving still free hydroxyl groups, which are used to react with the isocyanate.

The modification of nitrocellulose with a prepolymer derived from isocyanate results in a still thermosensitive molecule, however with reduced permeability, once part of its free hydroxyls has reacted with a prepolymer that contains free isocyanate groups, through urethane bond (which is insoluble and hydrophobic). To the extent to which the number of urethane bonds in the nitrocellulose polymer chain increases, this becomes more insoluble and more hydrophobic, until the polymer becomes thermoset, insoluble in organic solvents. It is worth emphasizing that, for the effects of the present invention, the hydroaffinity property was determined in a qualitative way.

Table 1, below, shows the types of nitrocellulose/isocyanate/solvents and their level of inclusion in molar terms.

TABLE 1
NCPU 1K - plasticizer

| | | NC | | | | |
|---|---|---|---|---|---|---|
| | | solution | | | | |
| Character- | | (27% | TDI/ | IPDI/ | HDI/ | MDI/ |
| ization | Unit | solids) | NC | NC | NC | NC |
| Viscosity | cP | 633 | 2400 | 3374 | 1800 | 2850 |
| Solid content | % | 27 | 34.5 | 36 | 35 | 36 |
| Density | g/mL | 1.04 | 1.06 | 1.08 | 1.06 | 1.06 |
| H2O content | % | 0.3 | 0.34 | 0.28 | 0.3 | 0.32 |
| Acidity | mg of | | 0.8 | 0.6 | 0.8 | 0.6 |
| | KOH/mg | | | | | |
| Color | Gardner | 1.3 | 1.1 | 6.2 | 6 | 10 |
| Hardness | Pencil | 3H | 4H | H | N/A | N/A |
| Adherence | Degree | 3 | 2 | 1 | N/A | N/A |
| Chemical | Ethyl | 0 | 1 | 0 | 0 | 1 |
| resistance | acetate | | | | | |
| | MEK | 0 | 0 | 1 | 0 | 0 |
| | Butyl | 3 | 3 | 2 | 2 | 3 |
| | glycol | | | | | |
| | Xylol | 3 | 3 | 3 | 3 | 3 |
| TACK | seconds | 10 | 9 | 10 | 10 | 9 |
| Brightness | ub | 24 | 30.6 | 26 | N/A | N/A |

Considering that hydrophobicity is an extremely important property for the effect of the present invention and that, to the extent that the number of urethane bonds in the nitrocellulose polymer chain is increased, this becomes more insoluble and more hydrophobic; the paragraph below discusses the chemical basis of this property in the sphere of the present invention. FIG. 2 shows the proposed structure for the urethane-nitrocellulose system.

As mentioned above, the reaction with a monofunctional isocyanate prepolymer gives rise to a still thermosensitive polymer whose dry film has reduced permeability, mainly if compared with the permeability of an untreated nitrocellulose film. In this latter, there are many hydrophilic groups resulting from the free residual hydroxyl groups, once the esterification with nitro groups is partial. These data can be experimentally verified by observing the brightness of the film, the depth of the image that is obtained or, in short, its reflection. When examining the facts relating to the greater hydrophobicity of the film, it is considered that the increase of urethane bonds leads to a reduction of the hydrophilic groups, represented for residual free hydroxyls of the nitrocellulose. There will also be an increase of viscosity to the extent that the level of blockage of the hydroxyl groups increases, until insolubility is reached, the molecular size of a thermoset polymer having then been reached.

The isocyanate prepolymer being linear and monofunctional, the flexibility of the film is achieved directly, without the necessity of using external plasticizers, so common among the formulators of nitrocellulose varnishes, pure or combined, with other film formers. Internal plastification allows flexibility to be achieved in the dry film as an inherent property of the polymer, it not taking an artificial form of an external plasticizer only mixed into the varnish.

### EXAMPLES

### 1. TDI, HDI and IPDI Glycol Ether

TABLE 2
Results for NCPU 1K - plasticizer

| | | NC | | | | |
|---|---|---|---|---|---|---|
| | | solution | | | | |
| Character- | | (27% | TDI/ | IPDI/ | HDI/ | MDI/ |
| ization | Unit | solids) | NC | NC | NC | NC |
| Viscosity | cP | 633 | 2400 | 3374 | 1800 | 2850 |
| Solid content | % | 27 | 34.5 | 36 | 35 | 36 |
| Density | g/mL | 1.04 | 1.06 | 1.08 | 1.06 | 1.06 |
| H2O content | % | 0.3 | 0.34 | 0.28 | 0.3 | 0.32 |
| Acidity | mg of | | 0.8 | 0.6 | 0.8 | 0.6 |
| | KOH/mg | | | | | |
| Color | Gardner | 1.3 | 1.1 | 6.2 | 6 | 10 |
| Hardness | Pencil | 3H | 4H | H | N/A | N/A |
| Adherence | Degree | 3 | 2 | 1 | N/A | N/A |
| Chemical | Ethyl | 0 | 1 | 0 | 0 | 1 |
| resistance | acetate | | | | | |
| | MEK | 0 | 0 | 1 | 0 | 0 |
| | Butyl | 3 | 3 | 2 | 2 | 3 |
| | glycol | | | | | |
| | Xylol | 3 | 3 | 3 | 3 | 3 |
| TACK | seconds | 10 | 9 | 10 | 10 | 9 |
| Brightness | ub | 24 | 30.6 | 26 | N/A | N/A |

### 2. MDI and Ether and HDI With Ether

TABLE 3
Results for NCPU 1K - plasticizer

| | | | | | | |
|---|---|---|---|---|---|---|
| | | NC | | | | |
| | | solution | | | | |
| Character- | | (27% | TDI/ | IPDI/ | HDI/ | MDI/ |
| ization | Unit | solids) | NC | NC | NC | NC |

| | | | | | |
|---|---|---|---|---|---|
| Viscosity | cP | 633 | 2400 | 2800 | 3640 |
| Solid content | % | 27 | 34.5 | 36 | 35 |
| Density | g/mL | 1.04 | 1.06 | 1.08 | 1.05 |
| H2O content | % | 0.3 | 0.34 | 0.3 | 0.3 |
| Acidity | mg of | | 0.8 | 0.6 | 0.8 |
| | KOH/mg | | | | |
| Color | Gardner | 1.3 | 1.1 | N/A | N/A |
| Hardness | Pencil | 3H | 4H | N/A | N/A |
| Adherence | Degree | 3 | 2 | N/A | N/A |
| Chemical | Ethyl | 0 | 1 | 0 | 0 |
| resistance | acetate | | | | |
| | MEK | 0 | 0 | 0 | 0 |
| | Butyl | 3 | 3 | 3 | 2 |
| | glycol | | | | |
| | Xylol | 3 | 3 | 3 | 3 |
| TACK | seconds | 10 | 15 | 15 | 15 |
| Brightness | ub | 24 | 30.6 | 30 | 30 |

Results

Hardness: 6B-5B-4B-3B-2B-B-HB-F-H-2H-3H-4H-5H-6H-7H

Degree of Adherence: 0-1-2-3-4 (0=excellent/4=very bad)

Chemical resistance to specific solvents: 3 resists/0 does not resist

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An extremely fast urethane-cellulose coating system comprising a product of a reaction between a cellulosic derivative and a monofunctional urethane derivative.

2. The coating system in accordance with claim 1, wherein the monofunctional urethane derivative is an aromatic isocyanate of the toluene diisocyanate (TDI) and diphenylmethane diisocyanate (MDI) type or an aliphatic of isophorone diisocyanate (IPDI) and hexane diisocyanate (HDI) type.

3. The coating system in accordance with claim 1, wherein the solvent is a solvent including glycols of the monoethylene glycol (MEG), diethylene glycol (DEG), propylene glycol (PG), dipropylene glycol (DPG), triethylene glycol (TEG), MPdiol, 1,4-butanediol, 1,6-hexanedionol, tripropylene glycol (TPG) type, glycolic ethers of the following types: monoethylene glycol methyl ether, monoethylene glycol ethyl ether, propylene glycol methyl ether, diethylene glycol methyl ether, triethylene glycol methyl ether, propylene glycol methyl ether, dipropylene glycol methyl ether, tripropylene glycol methyl glycolic ether and other ethers.

4. The coating system in accordance with claim 1, wherein aromatic isocyanates such as toluene diisocyanate trimers and toluene diisocyanate adducts with polyols such as trimethylolpropane and diphenylmethane diisocyanate resins are used.

5. The coating system in accordance with claim 1, wherein the nitrocellulose used possesses a nitrogen content between 10.8% and 12.3%.

6. The coating system in accordance with claim 1, wherein the nitrocellulose viscosity is in the range of ½ second, ¼ second, 18-25 seconds and 10-15 seconds.

7. The coating system in accordance with claim 1, wherein catalysts based on bismuth, zinc, tin, potassium, cobalt and zirconium are employed.

8. The coating system as defined in claim 1, wherein the coating system is a nitrocellulose-based urethane varnish for application on metal, aluminum, wood-based, solid, agglomerate and reconstituted, or thermoplastic, polyethylene (PE), high or low density, torsional or metallized or bi-oriented (BOPP) polypropylene (PP), polyester, polyethylene terephthalate (PET), homopolymer or suspension-type vinyl polymer (PVC) surfaces; with or without electric (corona), thermal or chemical treatment.

9. The coating system as defined in claim 1, wherein the coating system is a nitrocellulose-based urethane varnish for automobile repainting.

10. The coating system as defined in claim 1, wherein the coating system is a nitrocellulose-based urethane varnish for repainting wood.

11. The coating system as defined in claim 1, wherein the coating system is nitrocellulose-based urethane varnish in graphic arts.

12. The coating system as defined in claim 1, wherein the coating system is a hydrophobic urethane film.
